(19) United States
(12) Patent Application Publication
(10) Pub. No.: US 2008/0040300 A1
(43) Pub. Date: Feb. 14, 2008

(54) Computer system and the working method of this computer system of artificial intelligence of a cyborg or an android

(76) Inventor: Boris Kaplan, Munich (DE)

Correspondence Address: MR. BORIS KAPLAN, GUARDINISTR - 160, MUNICH, 81375, omitted

(21) Appl. No.: 11/355,287

(22) Filed: Feb. 16, 2006

(30) Foreign Application Priority Data
Oct. 21, 2005 (DE) DE102005050579

(51) Int. Cl. G06G 7/06

(52) U.S. Cl. 706/16

(57) ABSTRACT

A computer system as a computer system of AI of a cyborg or an android based on a natural language. The computer system includes the hardware devices 27, 28, 29, 30, 31, 32, 33, 34, 35, 36, 37, the sensors groups 1, 2, 3, 4, 5, 6, the interfaces 7, 8, 9, 10, 11, 12, 15, 16, 17, 18, 19, 20, 21, 22, 24, 25, the senses input receiver 13, the senses output transmitter 14, the database 23, the cyborg-interpreter 26. The natural language which the computer system uses with its working method is interpreted by the computer system in a object-oriented way. The objects are no objects of a computer language. The computer system uses the references for another language.

The present invention relates to a computer system and the working method of this computer system of artificial intelligence of a cyborg or an android. The system is based on a natural language.

Systems of artificial intelligence for the classification of events, objects or situations, for example, which provide the classification of seismic events, are known from the European patent (FR 9908472, DE 60005350). The systems are based on the fuzzy expert system (FES). This invention is not planned as a computer system of AI of a cyborg or an android as well as it is not based on a natural language.

From the European patent (JP 32376590, DE 69132026), a software work tool, which is used in software work for an information processing apparatus, is known. It manages software on the field of the artificial intelligence dynamically. The point from this invention is not a computer system of AI of a cyborg or an android. It is about the tool, which manages the software to runtime intelligently and dynamically.

A system for adding attributes to an object at run time in an object oriented computer environment is known from the European patent (US 96112432, DE 69616449). In this system, the procedure for assigning a property to an object by a computer system is implemented. The computer system contains a definition of a class, which specifies one or several class properties from an object, and the computer system adds attributes to an object to compile time at run time. The point from this invention is not a computer system of AI of a cyborg or an android. By object modeling, it is about the use of a computer language and a compiler.

A system and method using natural language understanding for speech controlled application are known by the European patent (US 93293897, DE 69814114). This invention relates, in general to computerized natural voice systems, in particular to a computer system and method for providing speech understanding abilities to an interactive voice response system or a computer system and method to interpreting of utterances by a speech recognition application, provided with boundary conditions. The computer system is based on a fix, predetermined, annotated ASR corpus file, which contains an enumeration of all expected valid utterances. This invention is not planned as a computer system of AI of a cyborg or an android.

In the European patent (EP 939187506, DE 69303013), the use of a language with a similar representation for programs and data by the distributed data processing is patented. This invention is based on a computer language.

By the European patent (KR 2003000254, DE 10361726), a robot toy with artificial intelligence and control method for it is patented. Several patent claims specific for a robot are disclosed by the patent. The AI of the robot toy is planned for its mechanical control.

Further, the humanoid robots are known which can move in human or animal way.

For example, ASIMO is a robot developed by company Honda which can move in human way.

The AIBO of company Sony, a robot-dog, which can be programmed. In addition, he can run, see, show his feelings and speak the predefined words.

The QRIO of company Sony. It is a humanoid robot itself, which can move in human way. He can do everything that the AIBO can do. He can also speak about something, or have a conversation. Besides, the speech recognition is used and the predefined response scenarios with many thousands of words are prepared. In addition, the ORIO is very expensive.

Further, the predicate logic is worldwide known. It plays a big role in informatics for the programming of expert's systems and AI. It is based on the logical predicate, which can take part as either a property or a relation between entities, but not as an action. The predicate is considered as not object-oriented. Neither the subject term nor the predicate term are considered relatively at the time.

The way of posing a problem of this invention is to improve the computer system of AI of a cyborg or an android. The computer system should be with his working method:
dependent on no hardware;
dependent on no operating system;
dependent on no computer language;
dependent on no code;
dependent on no software;
dependent on no software developer, by software developing;
dependent on no software developer, as a person, who considers all things with own subjectivity;
dependent on no database or another way to store data;
dependent on no the specific computer language column types, for example, Integer, Number, Universal Unique Identifier, Global Unique Identifier, etc., for creating all primary keys of the database tables.

The computer system should be economical for the further development relative to both the hardware devices and the software components.

The innovative solution accomplished by the present invention is that a natural language, which the computer system uses with its working method, is interpreted by the computer system as object-oriented. These objects are no objects of a computer language. The computer system functionality is based on these objects, which are defined relatively at the time, for example, which are provided with a timestamp. The objects are generated from a natural language and classified according to an action in a natural language. These objects generated by the natural language can represent some more reactions in each case from some more sensors groups than five reactions of five sense organs. The computer system uses the references for another language.

In details, summarizing follows the subjective first input of the incoming signals of the sensors groups by the computer system.

With subjective summarizing the incoming signals of the sensors groups by the computer system, a signal combination is created. Thus, a subjective object is determined for the computer system.

Then associative collecting the incoming signals of the sensors groups by the computer system to a phrase of a natural language follows. The combination of five incoming sensors groups signals with this phrase represents an associative object of the computer system. After processing by the cyborg-interpreter, this phrase is completed and defined relatively at the time, for example, it is provided with a timestamp. Associative collecting pursues goals that the associative object is completed, that it is stored uniquely for the long term, as well as that it can be found relatively at the time over and over again.

The phrase which contains the associative object is abstractly analyzed by the cyborg-interpreter at work. This phrase is parsed on the single words with abstract analyzing. Every parsed word is defined as the part of speech and/or as the part of a sentence. Then every word of the phrase will be analyzed abstractly, with regard to the class classification, the polymorphism, the units of measurement. Then every word of the phrase will be stored uniquely for the long term, classified according to an action in a natural language, with an analytic entity, with having consideration for the word order of the phrase, relatively at the time of summarizing the incoming signals of the sensors groups. In this way, a phrase stored word by word represents an abstract object of the computer system.

The computer system operates with this abstract object at work.

Thus, for example, a new class is specified in the class classification according to inheritance or a new unknown object is polymorphically arranged to an existing class.

The abstract object can be found by the computer system over and over again. The associative object will be found corresponding to the abstract object. The subjective object will be found corresponding to the associative object.

The subjective object can be returned.

The subjective object will be split into the single signals of the sensors groups on its return, i.e., the output mode, output value, and output unit of measurement will be defined for every output interface of the sensors groups.

The computer system uses a natural language for the working method. For the working method in the first, original, natural language, the computer system can use references in another natural language to words in the first, original, natural language. But the references, i.e. the abstract objects in another natural language, in another natural language to the abstract objects in the first, original, natural language are used by the computer system during the working method in the other natural language. The same logic will be used for several natural languages.

This invention is based on one of my scientific discoveries, and/or a theory, with the subject—“Human intelligence. Natural intelligence. The functionality of the human (natural) intelligence.”

This invention makes it possible either the conversion of a humanoid robot into an android or the conversion of a human into a cyborg with the artificial part—the artificial intelligence.

An enormous gigantic job potential, which includes thousands of highly qualified, highly motivated, high-quality jobs in the different branches, is hidden behind this invention.

Except the use of the computer system and the working method as a computer system and a working method of this computer system of AI of a cyborg or an android, the invention is susceptible of industrial application, for example:
1. in the manufacture of toys. In this way, a doll can be produced with a computer system of AI. The doll will communicate with the child actively. It can be used for education purposes. It can be used for teaching methods. It can be used as a friend for children . . .
2. in the medicine. Thus, a model of the central nervous system of a mentally ill or neurological ill patient can be implemented. The model will be used in the illness simulations and for the simulations of healing methods;
3. in the fight against crime. In this way, a model of the central nervous system of a criminal can be implemented. His steps can be pre-estimated with the model;
4. for counterterrorism. Thus, a model of the central nervous system of a terrorist can be implemented. Thus, the behavior and manners of the terrorists can be pre-estimated. Thus, for example, the future terrorist attacks can be prevented.

Other details, features and advantages result from the execution examples shown in the drawings, and from the independent and dependent claims. The execution examples follow the description.

In the drawings:

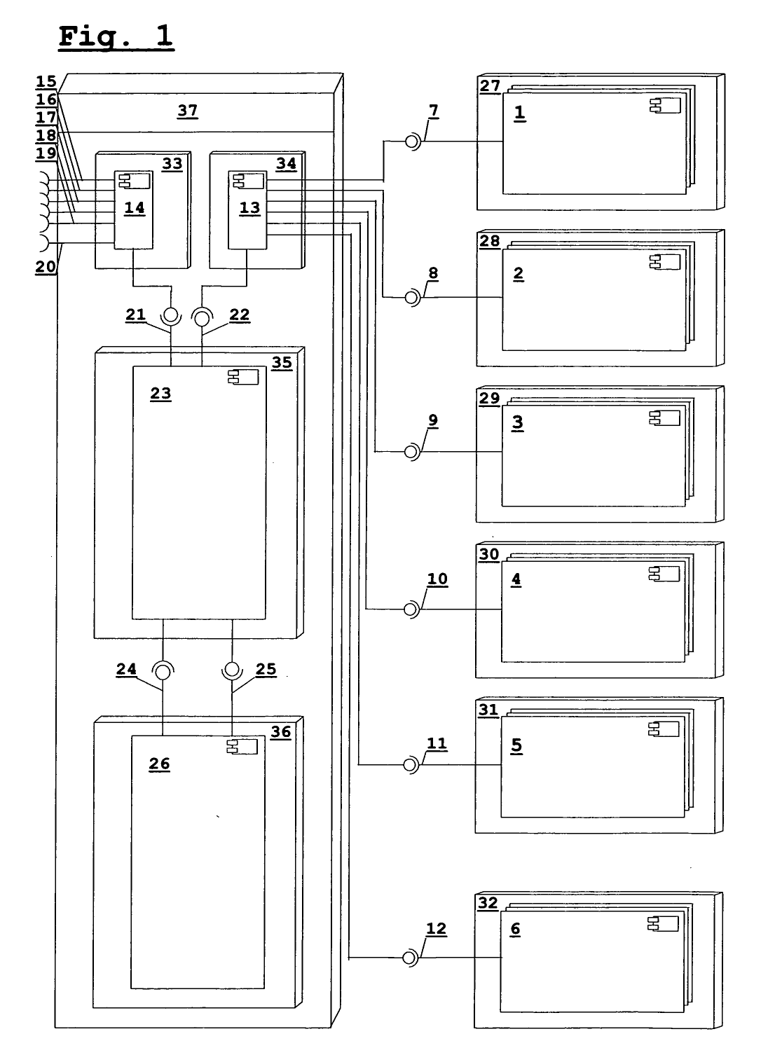

FIG. 1 shows a computer system of artificial intelligence of a cyborg or an android.

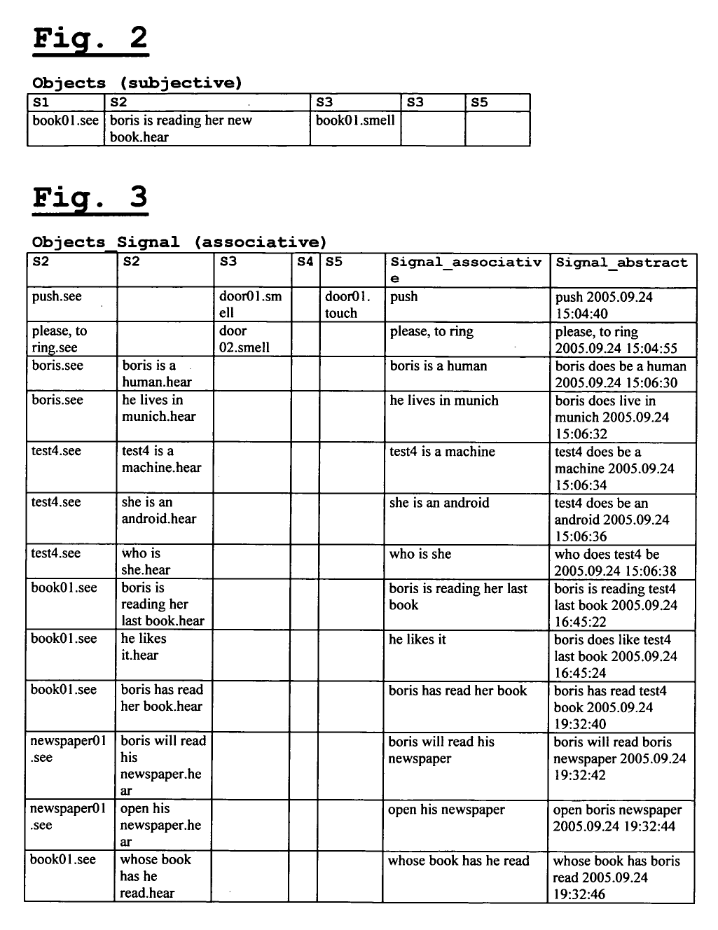

FIG. 2 illustrates the working method for the subjective first input of the incoming signals of the sensors groups by the computer system and subjective summarizing these signals to a subjective object.

FIG. 3 is an illustration of the working method for associative collecting the incoming signals of the sensors groups by the computer system relatively at the time to an associative object.

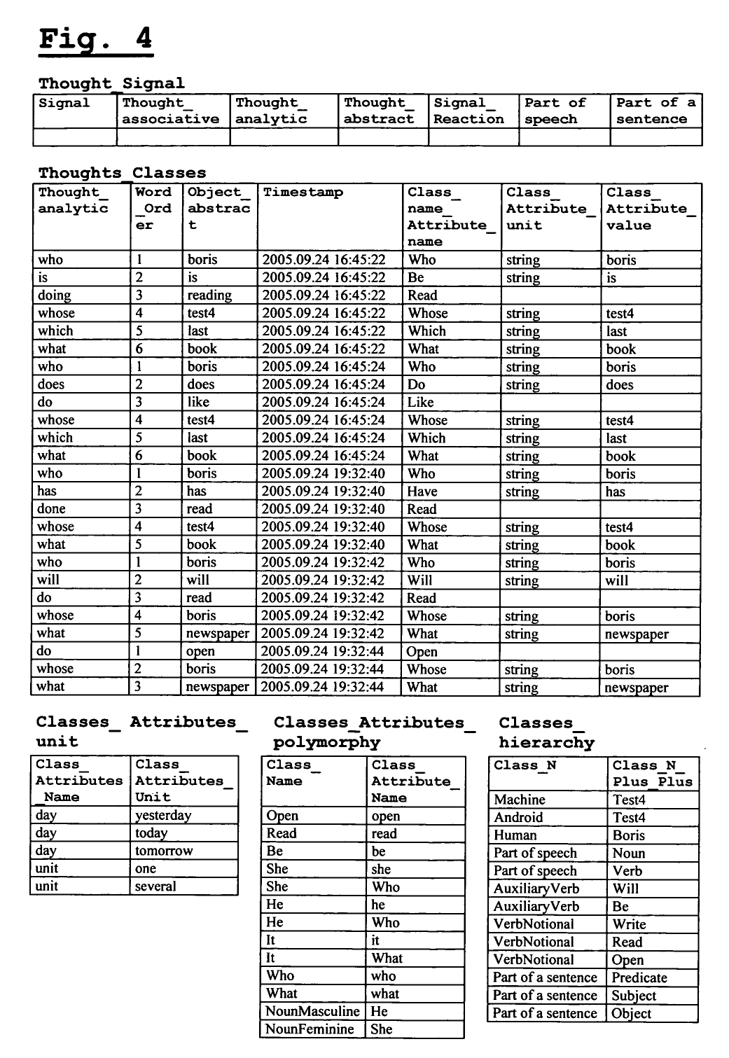

FIG. 4 illustrates the working method for abstract analyzing the abstract object of the computer system, abstract operating with the abstract object, abstract storing the abstract object and abstract finding the abstract object again.

FIG. 5 illustrates the working method for abstract transmitting back the abstract object of the computer system.

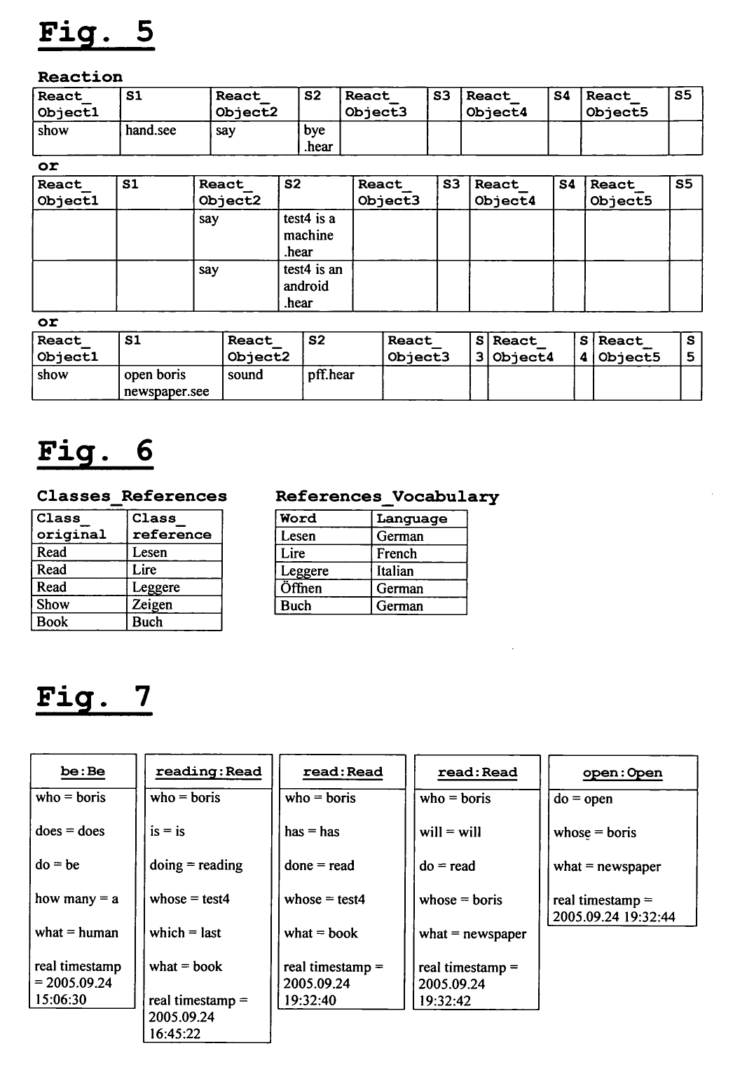

FIG. 6 illustrates the working method used by the computer system for working in another natural language or in several natural languages.

FIG. 7 shows some examples of the objects generated into the abstract objects in a natural language.

FIG. 1 shows a computer system of artificial intelligence of a cyborg or an android. Five sensors groups, the group of the sense of sight 1, the group of the sense of hearing 2, the group of the sense of smell 3, the group of the sense of taste 4, the group of the sense of touch 5, receive the incoming signals, summarize the signals to the particular signals, one from every group, i.e. a signal from the group of the sense of sight, a signal from the group of the sense of hearing, a signal from the group of the sense of smell, a signal from the group of the sense of taste, a signal from the group of the sense of touch, and transmit the signals at the same time. With the appropriate input interfaces, the seeing input interface 7, the hearing input interface 8, the smelling input interface 9, the degusting input interface 10, the touching input interface 11, the five signals come at the same time to the senses input receiver 13. The senses input receiver writes the five signals with the database input interface 22 at the same time to the database 23. The sixth sensors group demonstrates the sensors group of n-sense 6, as well as the sixth input interface demonstrates the input interface of n-sense 12. The cyborg-interpreter 26 accesses the data in the database with the interpreter input interface 24 and the interpreter output interface 25. The work results of the cyborg-interpreter are stored in the database. With the database output interface 21, with the senses output transmitter 14, and with the five output interfaces: the show output interface 15, the sound output interface 16, the scent output interface 17, the taste output interface 18, the touch output interface 19, the five prepared output signals are read at the same time from the outside. The sixth output interface demonstrates the output interface of n-sense 20. The hardware devices nodes are illustrated under the number 27, 28, 29, 30, 31, 32, 33, 34, 35, 36. They are implemented for the test and demo purposes as some different computers. The peripheral devices as well as the microcontrollers will be used for production. The internal hardware environment is illustrated under the number 37.

In another implementation, particular signals are stored with the senses input receiver on the hard disk into the signal data files and can be returned with the senses output transmitter. The names of the signal data files are written with the database input interface into the database and will be read with the database output interface from the database. In this case, the object of the sense organs is created from the names of the files. In this case also, all data is stored in the database only as a single data type, for example the character string. In this case, the computer system is independent of the database, or it needs a quite simple database.

The other drawings illustrate the working method of computer system of AI of a cyborg or an android.

FIG. 2 illustrates the working method for the subjective first input of the incoming signals of the sensors groups by the computer system and subjective summarizing these signals to a subjective object. Five subjectively incoming signals are stored subjectively to a subjective object. S1 stands for the sense of sight signal, S2 stands for the sense of hearing signal, S3 stands for the sense of smell signal, S4 stands for the sense of taste signal, S5 stands for the sense of touch signal. The columns definition of the database gives the possibility to store a appropriate signal in every column. In another implementation, only the names of files are stored in the database. Every subjective object is unique. It will be stored in the database uniquely, relative to S1, S2, S3, S4, S5. It will be deleted from the database after the data processing.

(The table Objects (subjective) is implemented with the primary key relative to S1, S2, S3, S4, S5. The primary key is created without the specific computer language column types, for example, Integer, Number, Universal Unique Identifier, Global Unique Identifier, etc. The other database tables are created in the same way.)

FIG. 3 is an illustration of the working method for associative collecting the incoming signals of the sensors groups by the computer system relatively at the time to an associative object. The incoming, subjective, concrete object is described, for example as a Signal_associative, with a phrase. This phrase and five incoming signals S1, S2, S3, S4, and S5 define an associative object. As a result of the work of the cyborg-interpreter this phrase is completed. It is defined relatively at the time (for example is provided with timestamp, uniquely, and is stored as a Signal_abstract in the database). In addition, the associative object is stored for the computer system uniquely, relative to S1, S2, S3, S4, S5, the phrase and the relative definition at the time, for the long term.

(The table Objects_Signal (associative) is implemented with the primary key relative to S1, S2, S3, S4, S5, and for example Signal_abstract, i.e., the timestamp needn't be unique as well. The other database tables are created in the same way.)

FIG. 4 illustrates the working method for abstract analyzing the abstract object of the computer system, abstract operating with the abstract object, abstract storing the abstract object and abstract finding the abstract object again. For abstract analyzing, the cyborg-interpreter uses the phrase which contains the associative object. This phrase is parsed on the single words. Every parsed word is defined as the part of speech and/or as the part of a sentence. Then every word of the phrase will be analyzed abstractly, with regard to the class classification, the polymorphism, the units of measurement.

Then every word of the phrase will be stored uniquely for the long term, classified according to an action in a natural language, with an analytic entity, with having consideration for the word order of the phrase, relatively at the time of summarizing the incoming signals of the sensors groups. In this way, a phrase stored word by word represents an abstract object of the computer system.

The computer system operates with this abstract object at work.

For example, thus, a new class is specified in the class classification according to inheritance or a new unknown object is polymorphically arranged to an existing class.

The abstract object can be found by the computer system over and over again. The associative object will be found corresponding to the abstract object. The subjective object will be found corresponding to the associative object.

The subjective object can be returned.

FIG. 5 illustrates the working method for abstract transmitting back the abstract object of the computer system. The subjective object is split into the single signals of the sensors groups on its return, i.e. the output mode, output value, and output unit of measurement will be defined for every output interface of the sensors groups. For example, the output modes: React_Object1, React_Object2, React_Object3, React_Object4, React_Object5, the output values: S1, S1, S2, S3, S4 and S5. In addition, the output units of measurement can be also defined.

FIG. 6 illustrates the working method used by the computer system for working in another natural language or in several natural languages. The computer system uses a natural language for the working method. For the working method in the first, original, natural language, the computer system can use references in another natural language to words in the first, original, natural language. Thus, it is illustrated that the computer system uses only one natural language for its working method.

But for working method in another natural language, the computer system needs the abstract objects in the other natural language. Therefore, the computer system will use the references (i.e. the abstract objects in another natural language) in another natural language to the abstract objects in the first, original, natural language during the working method in the other natural language. The same logic will be used for several natural languages.

FIG. 7 shows some examples of the objects generated into the abstract objects in a natural language. Each abstract object is defined relatively at the time (for example is provided with timestamp). Each abstract object represents an action in the same natural language. The computer system operates with the objects during its working method. The classes from the objects or the objects themselves are preprogrammed in no computer language.

There follow 4 sheets of drawings.

1. A computer system as a computer system of AI of a cyborg or an android based on a natural language, consisting of the hardware devices 27, 28, 29, 30, 31, 32, 33, 34, 35, 36, 37, the sensors groups 1, 2, 3, 4, 5, 6, the interfaces 7, 8, 9, 10, 11, 12, 15, 16, 17, 18, 19, 20, 21, 22, 24, 25, the senses input receiver 13, the senses output transmitter 14, the database 23, the cyborg-interpreter 26, characterized in that
the computer system subjectively summarizes a combination-set of some reactions of the respective sensors groups, as an object which is preprogrammed in no computer language.

2. Computer system according to claim 1, characterized in that
the computer system defines this object as an action in a natural language.

3. Computer system according to claim 1, characterized in that
the computer system treats this object relatively at the time.

4. Computer system according to one or several the claims 1-2, characterized in that
the computer system uses a word in another natural language as a reference to a word in the first natural language for working method in the in the first natural language.

5. Computer system according to one or several the claims 1-3, characterized in that
the computer system can summarize under this object some more reactions in each case from some more sensors groups than five reactions of five sense organs.

6. Computer system according to one or several the claims 1-5, characterized in that
the computer system provides for output this object, split according to the sensors groups.

7. Computer system according to one or several the claims 1-6, characterized in that
all of the primary keys from database tables are implemented without the specific computer language column types but with the column combinations from the respective database tables.

8. The working method of this computer system of AI, characterized in that
the working method includes the following steps:
summarizing, subjectively relating to the computer system, the respective sensors groups reactions to a subjective object;
collecting, associatively relating to the computer system, the incoming sensors groups signals to an associative object, wherein:
the associative object is completed,
the associative object is provided relatively at the time;
analyzing, abstractly relating to the computer system,
word by word,
with the part of speech,
as a part of a sentence,
with regard to the class classification, the polymorphism, the units of measurement,
with regard to intonation;
storing the abstract object, classified according to an action in a natural language,
word by word,
with an analytic entity or some analytic entities,
with having consideration for the word order of the phrase,
relatively at the time;
operating of the abstract object;
finding the associative object;
finding again the subjective object;
the return of the subjective object;

9. The working method according to claim 8, characterized in that
a reference in another natural language to the abstract object is used for working method in the other natural language.
